(19) United States
(12) Patent Application Publication
(10) Pub. No.: US 2022/0212499 A1
(43) Pub. Date: Jul. 7, 2022

(54) TIRE TREAD HAVING IMPROVED ROLLING RESISTANCE AND WEAR

(71) Applicants: Chaitra Mahesha TRIF, Greenville, SC (US); Greg GOSSWEILER, Greenville, SC (US); Compagnie Generale des Etablissements Michelin, Clermon-Ferrand (FR)

(72) Inventors: Chaitra Mahesha TRIF, Greenville, SC (US); Greg GOSSWEILER, Greenville, SC (US)

(21) Appl. No.: 17/604,438

(22) PCT Filed: Apr. 18, 2019
(86) PCT No.: PCT/US19/28137

§ 371 Date: Oct. 17, 2021

(51) Int. Cl. B60C 1/00; B60C 11/02; B60C 11/00; C08L 9/06; C08K 3/36; C08K 3/013; C08L 7/00

(52) U.S. Cl. CPC B60C 1/0016; B60C 11/02; B60C 11/0008; B60C 2200/06; C08K 3/36; C08K 3/013; C08L 7/00; C08L 9/06

(57) ABSTRACT

Rubber compositions and treads made from such rubber compositions, the rubber composition based upon a cross-linkable rubber composition, the cross-linkable rubber composition having between 15 phr and 45 phr of a modified styrene butadiene rubber, between 55 phr and 85 phr of a polyisoprene rubber and no more than 5 phr of a third diene rubber component. Such rubber compositions may further include between 35 phr and 60 phr of a silica reinforcing filler and a sulfur curing system. The modified styrene butadiene rubber that is useful for the rubber compositions disclosed herein have a glass transition temperature of no more than −70° C. and is modified with an active moiety that interacts with the silica.

### BACKGROUND OF THE INVENTION

### Field of the Invention

This invention relates generally tires for heavier vehicles and more particularly to rubber compositions for manufacturing treads for heavier vehicles.

### Description of the Related Art

Tire wear is of concern to those who must purchase tires because the greater the tire wear, the more expensive it is to operate a vehicle due to the expense of replacing worn tires. This is of more concern to those who operate large fleets of vehicles such as truck fleets or bus lines.

Improving tire wear is often a tradeoff that must be made against another valued physical property of a tire such as, for example, rolling resistance. The greater the rolling resistance of a tire, the higher the fuel consumption may be and the higher the operating costs.

Those skilled in the art of rubber compositions know that there are limits in the manufacturing plants for mixing rubber compositions and forming useful articles from them. If a rubber composition cannot be effectively processed in the manufacturing facility, then the rubber composition has little value.

It is known in the industry that tire designers must often compromise on certain characteristics of the tires they are designing. Changing a tire design to improve one characteristic of the tire will often result in a compromise; i.e., an offsetting decline in another tire characteristic. One such comprise exists between tire wear, rolling resistance, and processability. Tire designers and those conducting research in the tire industry search for materials and tire structures that can break these compromises.

### SUMMARY OF THE INVENTION

Particular embodiments of the present invention include rubber compositions and their use at least in part in tires and tire treads. The tire treads are especially useful for heavy vehicles, especially long-haul over-the-road heavy trucks. Particular embodiments include tire treads comprising a rubber composition, the rubber composition based upon a cross-linkable rubber composition, the cross-linkable rubber composition comprising between 15 phr and 45 phr of a modified styrene butadiene rubber, between 55 phr and 85 phr of a polyisoprene rubber and no more than 5 phr of a third diene rubber component. Such rubber compositions may further include between 35 phr and 60 phr of a silica reinforcing filler and a sulfur curing system.

The modified styrene butadiene rubber that is useful for the rubber compositions disclosed herein have a glass transition temperature of no more than −70° C. and is modified with an active moiety that interacts with the silica. In particular embodiments, the polyisoprene rubber may be limited to natural rubber.

The foregoing and other objects, features and advantages of the invention will be apparent from the following more detailed descriptions of particular embodiments of the invention.

### DETAILED DESCRIPTION OF PARTICULAR EMBODIMENTS

Particular embodiments of the present invention include tire treads and tires having such treads, including tire treads suitable for a retreading process, and other useful articles manufactured at least in part with the rubber compositions disclosed herein. It has been found that when treads are made from such rubber compositions, the compromise between rolling resistance, wear, and processability of the green rubber (uncured rubber) may be broken. It is the unique combination of the materials that make up the disclosed rubber compositions that surprisingly provide this break in the known compromise.

Particular embodiments of such rubber compositions include a small amount of a low glass transition temperature (Tg) styrene butadiene rubber component mixed with natural rubber (or alternatively with synthetic polyisoprene) as the majority rubber component and reinforced with a silica filler. Because of the improved wear, rolling resistance, and processability of these disclosed rubber compositions, they are particularly useful for manufacturing treads for heavy truck tires as well as for medium duty vehicles.

The Federal Highway Administration (FHWA) provides a classification system for vehicles. Buses are Class 4. Medium trucks are Classes 5 and 6, having two axles, six tires or three-axles respectively. These classes are typically assigned maximum weight limits of between 16,000 to 19,500 pounds or between 19,500 to 26,000 pounds respectively. weight limits of between Heavy trucks are typically Classes 7-13 and include Class 7 having a maximum weight load of between 26,000 and 33,000 pounds with a single unit, i.e., not a tractor-trailer rig. Class 8 and higher classes are multiple unit trucks, e.g., a five-axle tractor-trailer combination, also called a semi or an 18-wheeler, is a Class 8 truck with a weight limit of greater than 33,000 pounds. The tire treads made from the rubber compositions disclosed herein, while they are useful for other types of treads, are particularly useful for Class 5 and above, alternatively for Class 7 and above. The tire treads are particularly useful for in long-haul over-the-road trucking service where low rolling resistance tires are valued for reducing fuel costs, especially for vehicles in classes 7, 8 and 9 or in classes 7 and higher. Such long-haul vehicles do not include, for example, dump trucks, cement trucks, garbage trucks and similar trucks that may be used both on-road and off road.

As is well known in the art, a tire tread may be mounted on a tire during a retreading process, wherein the old tread on a tire is ground off and a new tread band is bonded to the tire to provide new tread life for a used tire carcass. Such tread bands may be cured before they are bonded to a tire or may be cured after they are mounted on the tire.

It is well known that treads may be formed as tread bands and then later made a part of a tire or they be formed directly onto a tire carcass by, for example, extrusion and then cured in a mold.

As used herein, “phr” is “parts per hundred parts of rubber by weight” and is a common measurement in the art wherein components of a rubber composition are measured relative to the total weight of rubber in the composition, i.e., parts by weight of the component per 100 parts by weight of the total rubber(s) in the composition.

As used herein, elastomer and rubber are synonymous terms.

As used herein, “based upon” is a term recognizing that embodiments of the present invention are made of vulcanized or cured rubber compositions that were, at the time of their assembly, uncured. The cured rubber composition is therefore “based upon” the uncured rubber composition. In other words, the cross-linked rubber composition is based upon or comprises the constituents of the cross-linkable rubber composition.

Reference will now be made in detail to embodiments of the invention. Each example is provided by way of explanation of the invention. For example, features illustrated or described as part of one embodiment can be used with another embodiment to yield still a third embodiment. It is intended that the present invention include these and other modifications and variations.

As is known generally, a tire tread is the road-contacting portion of a vehicle tire that extends circumferentially about the tire. It is designed to provide the handling characteristics required by the vehicle; e.g., traction, dry braking, wet braking, cornering and so forth—all being preferably provided with a minimum amount of noise being generated and at a low rolling resistance.

Treads of the type that are disclosed herein include tread elements that are the structural features of the tread that contact the ground. Such structural features may be of any type or shape, examples of which include tread blocks and tread ribs. Tread blocks have a perimeter defined by one or more grooves that create an isolated structure in the tread while a rib runs substantially in the longitudinal (circumferential) direction and is not interrupted by any grooves that run in the substantially lateral direction or any other grooves that are oblique thereto.

As is known to those skilled in the art, a tread may be manufactured with more than one rubber composition. It is recognized that in particular embodiments of the present invention the entire tread and/or the entire undertread (that portion of the tread that is radially lower than the bottom of the tread grooves) may be constituted from the rubber compositions disclosed herein while in other embodiments only portions of the tread and/or portions of the undertread may be constituted from the rubber composition or combinations of such thereof.

For example, in particular embodiments only some of the tread blocks/ribs on a tread may be made of the disclosed rubber composition while in other embodiments only portions of individual tread blocks/ribs may be made of the disclosed rubber composition. The tread blocks/ribs of the tread may be of the composition and/or in other embodiments only the tread base may be made of the composition. The undertread (the portion of the tread radially lower than the bottom of the grooves) may be of the disclosed compositions or in other embodiments not of the disclosed compositions. In particular embodiments of the treads disclosed herein, the treads comprise at least 80% by volume of the rubber compositions disclosed herein or alternatively, at least 90% or 100% of such rubber compositions.

As noted above, particular embodiments of the rubber compositions disclosed herein that are useful for, inter alia, tire treads include a functionalized styrene butadiene rubber (SBR) having a Tg of no more than −70° C. and a polyisoprene rubber. Particular embodiments may include no other rubber component or alternatively no more than 5 phr of another rubber component.

SBR is a copolymer of styrene and butadiene and is one of the most commonly used rubbers. The microstructure of SBR is typically described in terms of the amount of bound styrene and the form of the butadiene portion of the polymer. A typical SBR that is often suitable for use in tires is around 25 wt. % bound styrene. However, since the Tg of the SBR increases as the styrene content increases, useful SBR's for the rubber compositions disclosed herein are limited to less than 20 wt. % bound styrene or alternatively less than 10 wt % or no more than 5 wt %. On the lower end of the scale, the bound styrene content may be at least 1 wt % or at least 2 wt %. Particular embodiments may have a bound styrene content of between 1 wt % and 20 wt % or alternatively between 1 wt % and 10 wt %, between 0.5 wt % and 5 wt %, between 0.5 wt % and 3 wt %, between 1 wt % and 3 wt %, between 2 wt % and 10 wt % or between 2 wt % and 5 wt %. Styrene content of the SBR is determined by near-infrared spectroscopy (NIR).

Because of the double bond present in the butadiene portion of the SBR, the butadiene portion is made up of three forms: cis-1,4, trans-1, 4 and vinyl-1,2. Typically as the vinyl content of the SBR increase, the Tg of the material also increases. SBR materials suitable for use as the low Tg SBR may be described as having a vinyl-1,2-bond content of between 4 mol. % and 30 mol. % or alternatively, between 4 mol. % and 25 mol. % or between 4 mol. % and 20 mol. %. The microstructure (relative distribution of the of the cis-1,4, trans-1, 4 and vinyl-1,2 units) of the SBR is determined by near-infrared spectroscopy (NIR).

To provide a tire tread having the improved performance in the compromise between wear, rolling resistance, and processability, useful SBR's have a glass transition temperature of no more than −70° C. or alternatively, no more than −75° C. or no more than −80° C. In particular embodiments, the SBR may have a glass transition temperature of between −105° C. and −70° C. or alternatively, between −100° C. and −75° C., between −100° C. and −80° C., between −95° C. and −75° C., between −95° C. and −80, or between −90° C. and −80° C. Glass transition temperatures for the low Tg SBR are determined by differential scanning calorimetry (DSC) according to ASTM E1356.

In particular embodiments the low Tg SBR is modified or functionalized, i.e., appended with active moieties as is well known in the industry. The backbone or the branch ends of the elastomers may be functionalized by attaching these active moieties to the ends or middle of the chains or to the backbone of the polymer. The functional groups are known to interact or react with the reinforcement filler, e.g., the silica, thereby improving the physical characteristics of the rubber composition. Examples of functionalized elastomers include silanol or polysiloxane end-functionalized elastomers, examples of which may be found in U.S. Pat. No. 6,013,718, issued Jan. 11, 2000, which is hereby fully incorporated by reference. More particularly U.S. Patent Publication 2019/0077887, published Mar. 14, 2019 and fully incorporated herein by reference, describes an SBR having a Tg of between −100° C. and −80° C. that is mid-chain functionalized with an alkoxysilane group having a moiety that is capable of interacting with the silica filler, e.g., amines, carboxylates. Other examples of functionalized elastomers include those having silanol groups at the chain end as described in U.S. Pat. No. 6,013,718, or carboxylic groups as described in U.S. Pat. No. 6,815,473.

In addition to the low Tg SBR component, the rubber compositions disclosed herein further include a large amount of polyisoprene rubber and optionally a small amount of a third diene rubber component. Diene rubbers are understood to be those rubbers resulting at least in part, i.e., a homopolymer or a copolymer, from diene monomers, i.e., monomers having two double carbon-carbon bonds, whether conjugated or not. These diene rubbers may be classified as either “essentially unsaturated” diene rubbers or “essentially saturated” diene rubbers. As used herein, essentially unsaturated diene rubbers are diene rubbers resulting at least in part from conjugated diene monomers, the essentially unsaturated diene rubbers having a content of such members or units of diene origin (conjugated dienes) that is at least 15 mol. %. Within the category of essentially unsaturated diene rubbers are highly unsaturated diene rubbers, which are diene rubbers having a content of units of diene origin (conjugated diene) that is greater than 50 mol. %. Natural rubber is a highly unsaturated diene rubber.

Those diene rubbers that do not fall into the definition of being essentially unsaturated are, therefore, the essentially saturated diene rubbers. Such rubbers include, for example, butyl rubbers and copolymers of dienes and of alpha-olefins of the EPDM type. These diene rubbers have low or very low content of units of diene origin (conjugated dienes), such content being less than 15 mol. %. Particular embodiments of the rubber compositions disclosed herein may be limited to rubber compositions that are only highly unsaturated diene rubbers.

Examples of suitable conjugated dienes include, in particular, 1,3-butadiene, 2-methyl-1,3-butadiene, 2,3-di(C₁-C₅ alkyl)-1,3-butadienes such as, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene. Examples of vinyl-aromatic compounds include styrene, ortho-, meta- and para-methylstyrene, the commercial mixture “vinyltoluene”, para-tert-butylstyrene, methoxystyrenes, chloro-styrenes, vinylmesitylene, divinylbenzene and vinylnaphthalene.

Suitable diene rubbers as the optional rubber component for particular embodiments of the present invention include highly unsaturated diene rubbers such as, for example, polybutadienes (BR), synthetic polyisoprenes (IR), natural rubber (NR), butadiene copolymers, isoprene copolymers and mixtures of these rubbers. Such copolymers include, for example, butadiene/styrene copolymers (SBR), isoprene/butadiene copolymers (BIR), isoprene/styrene copolymers (SIR) and isoprene/butadiene/styrene copolymers (SBIR).

In particular embodiments, the polyisoprene portion of the rubber composition is only natural rubber or alternatively, at least 90 wt % of the polyisoprene portion is natural rubber, the remaining of remaining of the portion being synthetic polyisoprene.

As noted above, particular embodiments of the rubber compositions disclosed herein must include the low-Tg SBR and the polyisoprene rubber. Other embodiments may optionally include one or more additional highly unsaturated diene elastomers but only in quantities of between 0 phr and 5 phr of the total amount of all such optional rubbers or alternatively between 0 phr and 3 phr or 0 phr.

The rubber compositions may include between 15 phr and 45 phr of the styrene butadiene rubber component or alternatively between 15 phr and 40 phr, between 15 phr and 30 phr, or between 20 phr and 30 phr. Such rubber compositions further include between 55 phr and 85 phr of polyisoprene rubber, which may be limited to only natural rubber (or at least 90 wt % of the total polyisoprene portion is NR) or alternatively between 60 phr and 85 phr, between 70 phr and 80 phr or between 70 phr and 80 phr of such rubber.

In addition to the rubber components disclosed above, particular embodiments of the rubber compositions further include a silica reinforcing filler. Reinforcing fillers are added to rubber compositions to, inter alia, improve their tensile strength and wear resistance.

Useful silica reinforcing fillers known in the art include fumed, precipitated and/or highly dispersible silica (known as “HD” silica). Examples of highly dispersible silicas include Ultrasil 7000 and Ultrasil 7005 from Evonik, the silicas Zeosil 1165MP, 1135MP and 1115MP from Solvay, the silica Hi-Sil EZ150G from PPG and the silicas Zeopol 8715, 8745 and 8755 from Huber. In particular embodiments, the silica may have a BET surface area, for example, of between 100 m²/g and 250 m²/g or alternatively between 100 m²/g and 230 m²/g, between 100 m²/g and 200 m²/g or between 150 m²/g and 190 m²/g. Particular embodiments may have a CTAB as determined according to ISO 5794 of between 110 m²/g and 200 m²/g or alternatively between 130 m²/g and 190 m²/g or between 140 m²/g and 180 m²/g.

Particular embodiment of the rubber compositions may include between 35 phr and 60 phr of the silica filler or alternatively between 40 phr and 60 phr, between 40 phr and 55 phr or between 45 phr and 55 phr. Amounts that are less than this range do not provide the desired rigidity of the cured composition and amounts greater than this range provide unacceptable hysteresis of the uncured rubber composition, which has an unfavorable impact on rolling resistance. Larger amounts also impact the processability of the uncured rubber composition with a higher Mooney viscosity.

In addition to the rubber components and the silica reinforcing filler described above, particular embodiments of the rubber compositions may include a small amount of carbon black. Carbon black is also a reinforcing filler but may be added to rubber compositions to give the expected black color of tires. Suitable carbon blacks of the type HAF, ISAF and SAF, for example, are conventionally used in tire treads. Non-limitative examples of carbon blacks include, for example, the N115, N134, N234, N299, N326, N330, N339, N343, N347, N375 and the 600 series of carbon blacks, including, but not limited to N630, N650 and N660 carbon blacks.

The amount of carbon black included in the rubber compositions disclosed herein may range between 0 phr and 10 phr or alternatively between 0 phr and 5 phr, between 1 phr and 6 phr or between 1 phr and 4 phr of carbon black. Some embodiments may include no carbon black.

In addition to the rubber components and the silica and carbon black reinforcing fillers described above, particular embodiments of the rubber compositions include a silica coupling agent. When silica is added to the rubber composition, a proportional amount of a coupling agent is also added to the rubber composition. A suitable coupling agent is one that is capable of establishing a sufficient chemical and/or physical bond between the inorganic filler and the diene elastomer; which is at least bifunctional, having, for example, the simplified general formula “Y-T-X”, in which: Y represents a functional group (“Y” function) which is capable of bonding physically and/or chemically with the inorganic filler, such a bond being able to be established, for example, between a silicon atom of the coupling agent and the surface hydroxyl (OH) groups of the inorganic filler (for example, surface silanols in the case of silica); X represents a functional group (“X” function) which is capable of bonding physically and/or chemically with the diene elastomer, for example by means of a sulfur atom; T represents a divalent organic group making it possible to link Y and X.

Silane coupling agents are well known and are sulfur-containing organosilicon compounds that react with the silanol groups of the silica during mixing and with the elastomers during vulcanization to provide improved properties of the cured rubber composition. Any of the organosilicon compounds that contain sulfur and are known to one having ordinary skill in the art are useful for practicing embodiments of the present invention. Examples of suitable silane coupling agents having two atoms of silicon in the silane molecule include 3,3′-bis(triethoxysilylpropyl) disulfide and 3,3′-bis(triethoxy-silylpropyl) tetrasulfide (known as Si69). Both of these are available commercially from Evonik as X75-S and X50-S respectively, though not in pure form. Evonik reports the molecular weight of the X50-S to be 532 g/mole and the X75-S to be 486 g/mole. Both of these commercially available products include the active component mixed 50-50 by weight with a N330 carbon black.

Other examples of suitable silane coupling agents having two atoms of silicon in the silane molecule include 2,2′-bis(triethoxysilylethyl) tetrasulfide, 3,3′-bis(tri-t-butoxy-silylpropyl) disulfide and 3,3′-bis(di t-butylmethoxysilylpropyl) tetrasulfide. Examples of silane coupling agents having just one silicon atom in the silane molecule include, for example, 3,3′(triethoxysilylpropyl) disulfide and 3,3′ (triethoxy-silylpropyl) tetrasulfide. The amount of silane coupling agent can vary over a suitable range as known to one having ordinary skill in the art. Typically the amount added is between 7 wt. % and 15 wt. % or alternatively between 8 wt. % and 12 wt. % or between 9 wt. % and 11 wt. % of the total weight of silica added to the rubber composition.

Particular embodiments of the rubber composition disclosed herein include no processing oil or liquid plasticizers. Oils and other liquid plasticizers are useful for improving the processability of rubber compositions but do so typically with a compromise of reducing wear. Surprisingly particular embodiments of the rubber compositions disclosed herein do not require such a processing aid.

Oils and liquid plasticizers are well known to those having ordinary skill in the art. Examples include oils extracted from petroleum, vegetable oils, and low molecular weight polymers. Those extracted from petroleum may be classified as being paraffinic, aromatic or naphthenic type processing oil and including MES and TDAE oils. Those that are vegetable oils include, for example, rapeseed oil, and sunflower oil.

Some embodiments of the rubber compositions may include an elastomer, such as a synthetic polyisoprene, that has been extended with one or more such processing oils, but such oil is limited in the rubber compositions as being no more than 10 phr of the total elastomer content of the rubber compositions or alternatively, no more than 8 phr, no more than 6 phr or no more than 4 phr. Other embodiments include no such extended elastomers.

While particular embodiments of the rubber compositions disclosed herein include no liquid plasticizers, other embodiments may include no more than 10 phr of a liquid plasticizer or alternatively no more than 5 phr or no more than 2 phr of a liquid plasticizer.

Particular embodiments of the rubber composition disclosed herein include no plasticizing resins. Plasticizing resins are useful for, inter alia, improving processability of the rubber compositions but do so typically with a compromise of reducing wear. Surprisingly particular embodiments of the rubber compositions disclosed herein do not require such a processing aid.

Plasticizing resins are well known to those having ordinary skill in the art and are generally hydrocarbon based, often being petroleum based or plant based. Useful plasticizing resins typically are high Tg (glass transition temperature greater than 25° C.) though other resins are useful with lower Tg's. Examples of useful resins include terpene phenolic resins marketed by Arizona Chemical such as SYLVARES with varying softening points (SP), glass transition temperatures (Tg) hydroxyl numbers (HN), number-average molecular masses (Mn) and polydispersity indices (Ip), examples of which include: SYLVARES TP105 (SP: 105° C.; Tg: 55° C.; HN: 40; Mn: 540; Ip:1.5); SYLVARES TP115 (SP: 115° C.; Tg: 55° C.; HN: 50; Mn: 530; Ip:1.3); and SYLVARES TP2040 (SP: 125° C.; Tg: 80° C.; HN: 135-150; Mn: 600; Ip:1.3).

Examples of other resins include the OPPERA resins available from ExxonMobil, these resins being modified aliphatic hydrocarbon resins, and SYLVARES 600 resin (Mₙ 850 g/mol; Ip 1.4; T_{g} 47° C.; HN of 31 mg KOH/g) that is an octyl phenol-modified copolymer of styrene and alpha methyl styrene as well as the coumarone-indene resins.

It may be noted that the glass transition temperatures of plasticizing resins may be measured by Differential Scanning calorimetry (DCS) in accordance with ASTM D3418 (1999).

While particular embodiments of the rubber compositions disclosed herein include no such plasticizing resins, other embodiments may include no more than 5 phr of a resin or alternatively no more than 3 phr or no more than 1 phr of a plasticizing resin.

The rubber compositions disclosed herein may be cured with any suitable sulfur curing system. Particular embodiments are cured with a sulfur curing system that includes free sulfur and may further include, for example, one or more of accelerators, stearic acid and zinc oxide. Stearic acid and zinc oxides are well known vulcanization activators in sulfur curing systems. Suitable free sulfur includes, for example, pulverized sulfur, rubber maker's sulfur, commercial sulfur, and insoluble sulfur. The amount of free sulfur included in the rubber composition is not limited and may range, for example, between 0.5 phr and 10 phr or alternatively between 0.5 phr and 5 phr or between 0.5 phr and 3 phr. Particular embodiments may include no free sulfur added in the curing system but instead include sulfur donors.

Accelerators are used to control the time and/or temperature required for vulcanization and to improve the properties of the cured rubber composition. Particular embodiments of the present invention include one or more accelerators. One example of a suitable primary accelerator useful in the present invention is a sulfenamide. Examples of suitable sulfenamide accelerators include n-cyclohexyl-2-benzothiazole sulfenamide (CBS), N-tert-butyl-2-benzothiazole Sulfenamide (TBBS), N-Oxydiethyl-2-benzthiazolsulfenamid (MBS) and N′-dicyclohexyl-2-benzothiazolesulfenamide (DCBS). Combinations of accelerators are often useful to improve the properties of the cured rubber composition and the particular embodiments include the addition of secondary accelerators.

Particular embodiments may include as a secondary accelerant the use of a moderately fast accelerator such as, for example, diphenylguanidine (DPG), triphenyl guanidine (TPG), diorthotolyl guanidine (DOTG), o-tolylbigaunide (OTBG) or hexamethylene tetramine (HMTA). Such accelerators may be added in an amount of up to 4 phr, between 0.5 and 3 phr, between 0.5 and 2.5 phr or between 1 and 2 phr. Particular embodiments may exclude the use of fast accelerators and/or ultra-fast accelerators such as, for example, the fast accelerators: disulfides and benzothiazoles; and the ultra-accelerators: thiurams, xanthates, dithiocarbamates and dithiophosphates.

Other additives can be added to the rubber compositions disclosed herein as known in the art. Such additives may include, for example, some or all of the following: antidegradants, antioxidants, fatty acids, waxes. Examples of antidegradants and antioxidants include 6PPD, 77PD, IPPD and TMQ and may be added to rubber compositions in an amount, for example, of from 0.5 phr and 5 phr. Zinc oxide may be added in an amount, for example, of between 0.5 phr and 6 phr or alternatively, of between 1.0 phr and 4 phr. Waxes may be added in an amount, for example, of between 1 phr and 5 phr. Stearic acid may be added in an amount, for example, of between 1 phr and 6 phr or alternatively, of between 1.5 phr and 4 phr.

As noted previously, the rubber compositions disclosed herein break the compromise in the properties of hysteresis and wear without a significant impact on rigidity and processability. Particular embodiments of the rubber compositions disclosed herein provide a low hysteresis characteristic, which corresponds with lower rolling resistance, with a tan delta maximum of between 0.075 and 0.013 or alternatively between 0.08 and 0.12, between 0.08 and 0.11 or between 0.08 and 0.10. The tan delta maximum is measured at 60° C. in accordance with ASTM D5992-96 as described below.

Particular embodiments of the rubber compositions disclosed herein provide higher shear modulus. The shear modulus G*(50% strain) for particular embodiments of the rubber compositions disclosed herein is at least 1.0 MPa or alternatively at least 1.3 MPa or between 1.0 MPa and 2.5 MPa or alternatively between 1.1 MPa and 2.3 MPa or between 1.2 MPa and 2.0 MPa. The shear modulus G*(50% strain) is measured at 60° C. in accordance with ASTM D5992-96 as described below.

Particular embodiments of the rubber compositions disclosed herein provide good processability as demonstrated by their Mooney viscosities. The Mooney viscosity for particular embodiments is no greater than 130 MU or alternatively no greater than 125 MU or between 70 MU and 130 MU, between 70 MU and 125 MU or between 80 MU and 110MU or between 80 MU and 100 MU. The Mooney viscosity is measured at 100° C. in accordance with ASTM D 1646-1999 as described below.

Particular embodiments of the rubber compositions disclosed herein may additionally be described as having at one of the defined measurements provided above of at least two of the three characteristics of tan delta, G*(50% strain) and Mooney viscosity. Other embodiments may additionally have all three of the characteristics. For example, particular embodiments may have a tan delta max of between 0.075 and 0.013 and a G*(50% strain) of at least 1.0 MPa. Other embodiments have at least the measurements provided above in max tan delta and G*(50% strain).

The rubber compositions that are embodiments of the present invention may be produced in suitable mixers, such as in internal mixer, in a manner known to those having ordinary skill in the art. There are typically two successive preparation phases, a first phase of thermo-mechanical working at high temperature, followed by a second phase of mechanical working at lower temperature.

The first phase of thermo-mechanical working (sometimes referred to as “non-productive” phase) is intended to mix thoroughly, by kneading, the various ingredients of the composition, with the exception of the vulcanization system. It is carried out in a suitable kneading device, such as an internal mixer or an extruder, until, under the action of the mechanical working and the high shearing imposed on the mixture, a maximum temperature generally between 120° C. and 190° C., more narrowly between 130° C. and 170° C., is reached. Typically DPG is mixed in the first stage to provide a covering for the silica.

After cooling of the mixture, a second phase of mechanical working is implemented at a lower temperature. Sometimes referred to as “productive” phase, this finishing phase consists of incorporating by mixing the vulcanization (or cross-linking) system (sulfur, accelerators, activators), in a suitable device, for example an open mill although some or all of the accelerators and activators may be mixed in the non-productive phase. It is performed for an appropriate time (typically between 1 and 30 minutes, for example between 2 and 10 minutes) and at a sufficiently low temperature that is lower than the vulcanization temperature of the mixture, so as to protect against premature vulcanization.

The rubber composition can be formed into useful articles, including treads for use on vehicle tires. The treads may be formed as tread bands and then later made a part of a tire or they be formed directly onto a tire carcass by, for example, extrusion and then cured in a mold. As such, tread bands may be cured before being disposed on a tire carcass or they may be cured after being disposed on the tire carcass. Typically a tire tread is cured in a known manner in a mold that molds the tread elements into the tread, including, e.g., the sipes molded into the tread blocks or ribs.

The invention is further illustrated by the following examples, which are to be regarded only as illustrations and not delimitative of the invention in any way. The properties of the compositions disclosed in the examples were evaluated as described below and these utilized methods are suitable for measurement of the claimed properties of the claimed invention.

The Mooney viscosity ML(1+4) at 100° C. was measured in accordance with Standard ASTM D 1646 of 1999.

The maximum tan delta and complex shear modulus G* dynamic properties for the rubber compositions were measured at 60° C. on a Metravib Model VA400 ViscoAnalyzer Test System in accordance with ASTM D5992-96. The response of a sample of vulcanized material (double shear geometry with each of the two 10 mm diameter cylindrical samples being 2 mm thick) was recorded as it was being subjected to an alternating single sinusoidal shearing stress at a frequency of 10 Hz under a controlled temperature of 60° C. Scanning was effected at an amplitude of deformation of 0.1 to 100% peak to peak. The maximum value of the tangent of the loss angle tan delta (max tan 6) was determined during the outward cycle. The complex shear modulus G* was determined at 50% strain peak-to-peak during the outward cycle.

The tear resistance indices are measured at 100° C. The breaking load (FRD) is in N/mm of thickness and the elongation at break (ARD) in percentage are measured on a test piece of dimensions 10×142×2.5 mm notched with 3 notches that each have a depth of 3 mm. The tear resistance index (TR) was then provided as: TR=(FRD*ARD)/100.

Abrasion Performance Index was measured on an abrasion device on which a rubber sample piece was contacted with a spinning abrasive disk for a sliding length of 50 meters. The weight of the rubber sample piece was weighed before the test and after the test. The greater the mass loss during the test, the less effective is the rubber for wear performance. The Index for an inventive formulation was calculated by dividing the mass loss of the witness formulation by the mass loss of the inventive formulation and multiplying the result by 100. The higher the Index, the less mass loss compared to the witness formulation.

### Example 1

Rubber compositions were prepared using the components shown in Table 1. The amount of each component making up the rubber compositions are provided in parts per hundred parts of rubber by weight (phr). The BR was a high cis (>95) polybutadiene with a Tg of −108° C. The functionalized SBR had 2.5 wt % styrene, was mid-chain functionalized with an amino alkoxysilane moiety, and had a Tg of −88° C. The silica was ZEOSIL 1165MP from Evonik with a CTAB of 160 m²/g. The cure system included stearic acid, zinc oxide, CBS, DPG and sulfur.

TABLE 1
Formulations

| Formulations | W1 | W2 | W3 | F1 | F2 |
|---|---|---|---|---|---|
| BR | | 20 | 40 | | |
| NR | 100 | 80 | 60 | 80 | 60 |
| f-SBR | | | | 20 | 40 |
| N234 | | 4 | 4 | 4 | 4 |
| Silica | 50 | 50 | 50 | 50 | 50 |
| Liquid Si69 | | 5 | 5 | 5 | 5 |
| 6PPD | | 3 | 3 | 3 | 3 |
| Cure System | | 6 | 6 | 6 | 6 |

The rubber components, except the sulfur and non-DPG accelerator, were mixed in a Banbury mixer until a temperature of between 150° C. and 170° C. was reached. The sulfur and accelerator was added during the second phase on a mill. The rubber formulations were cured at between 140° C. and 150° C. The formulations were then tested to measure their properties, the results of which are shown in Table 2.

As can be seen in the results, the inventive formulations F1 and F2 demonstrated improved abrasion performance index and significant improvement in hysteresis properties without a significant penalty for the shear modulus rigidity. The abrasion performance index was the result of comparing the samples with that of Wl, which was assigned a value of 100.

TABLE 2
Physical Properties

| | W1 | W2 | W3 | F1 | F2 |
|---|---|---|---|---|---|
| Mooney (1 + 4), MU | 70 | 84 | 89 | 87 | 105 |
| Shear Modulus G*50% | 1.4 | 1.7 | 1.9 | 1.5 | 1.7 |
| @ 60° C., MPa | | | | | |
| Max Tan Delta @ 60° C. | 0.116 | 0.120 | 0.121 | 0.103 | 0.100 |
| Tear Resistance Index | 357 | 213 | 88 | 84 | 51 |
| Abrasion Perf Index | 100 | 134 | 183 | 132 | 184 |

### Example 2

This Example 2 was performed the same way and with the same materials as Example 1. The only difference was the amount of silica that was included in the formulations. Rubber compositions were prepared using the components shown in Table 3. The rubber formulations were cured just as in Example 1 and then tested to measure their properties, the results of which are shown in Table 4.

TABLE 3
Formulations

| Formulations | W4 | W5 | W6 | F3 | F4 | W7 | F5 |
|---|---|---|---|---|---|---|---|
| BR | | 20 | 40 | | | 40 | |
| NR | 100 | 80 | 60 | 80 | 60 | 60 | 60 |
| f-SBR | | | | 20 | 40 | | 40 |
| N234 | 4 | 4 | 4 | 4 | 4 | 4 | 4 |
| Silica | 40 | 40 | 40 | 40 | 40 | 60 | 60 |
| Liquid Si69 | 4 | 4 | 4 | 4 | 4 | 6 | 6 |
| Antidegradants | 3 | 3 | 3 | 3 | 3 | 3 | 3 |
| Cure System | 6 | 6 | 6 | 6 | 6 | 6 | 6 |

TABLE 4
Physical Properties

| Formulations | W4 | W5 | W6 | F3 | F4 | W7 | F5 |
|---|---|---|---|---|---|---|---|
| Mooney (1 + 4), MU | 60 | 70 | 79 | 76 | 94 | 103 | 123 |
| Shear G*50%, MPa | 1.0 | 1.3 | 1.5 | 1.1 | 1.3 | 2.4 | 2.4 |
| Max Tan Delta | 0.08 | 0.09 | 0.10 | .08 | .09 | 0.13 | 0.12 |
| Tear Resistance Ind. | 297 | 172 | 104 | 82 | 43 | 117 | 25 |
| Abrasion Perf Index | 67 | 98 | 130 | 92 | 130 | 223 | 231 |

Similar results were obtained in Example 2 as were obtained in Example 1. the inventive formulations F3, F4 and F5 demonstrated improved abrasion performance index and significant improvement in hysteresis properties without a significant penalty for the shear modulus rigidity.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A tire tread comprising a rubber composition, the rubber composition based upon a cross-linkable rubber composition, the cross-linkable rubber composition comprising:
between 15 phr and 45 phr of a modified styrene butadiene rubber, between 55 phr and 85 phr of a polyisoprene rubber and no more than 5 phr of a third diene rubber component;
between 35 phr and 60 phr of a silica reinforcing filler;
between 0 phr and less than 5 phr of a plasticizing resin; and
a sulfur curing system, wherein the modified styrene butadiene rubber has a glass transition temperature of no more than −70° C. and is modified with an active moiety that interacts with the silica reinforcing filler.

2. The tire tread of claim 1, wherein the modified styrene butadiene rubber has a styrene content of no more than 5 wt %.

3. The tire tread claim 2, wherein the modified styrene butadiene rubber has a Tg that is no more than −80° C.

4. The tire tread claim 3, wherein the polyisoprene rubber is at least 90 wt % a natural rubber.

5. The tire tread claim 4, wherein the third rubber component is a highly unsaturated diene rubber.

6. The tire tread claim 5, wherein the cross-linkable rubber composition comprises 0 phr of the third diene rubber component.

7. The tire tread claim 6, wherein the polyisoprene rubber is a natural rubber.

8. The tire tread claim 7, wherein the cross-linkable rubber composition comprises between 40 phr and 55 phr of the silica reinforcing filler.

9. The tire tread claim 8, wherein the cross-linkable rubber composition includes only the polyisoprene, the modified styrene butadiene and optionally the third diene rubber component as rubber components.

10. The tire tread claim 9, wherein the cross-linkable rubber composition includes none of the third diene rubber component.

11. The tire tread claim 10, wherein the cross-linkable rubber composition comprises between 15 phr and 30 phr of the modified styrene butadiene rubber.

12. The tire tread claim 11, wherein the cross-linkable rubber composition comprises between 20 phr and 30 phr of the modified styrene butadiene rubber.

13. The tire tread claim 12, wherein the cross-linkable rubber composition comprises no plasticizing liquid and no plasticizing resin.

14. The tire tread claim 13, wherein the tire tread is bonded to a heavy vehicle tire, wherein the heavy vehicle is for use on a Class 7 or higher vehicle.

15. The tire tread claim 14, wherein the rubber composition has a max tan delta of between 0.075 and 0.013 and a G*(50% strain) of at least 1.0 MPa.

16. The tire tread claim 15, wherein the tire tread is a tread strip for bonding to a tire during a retreading process.

17. A tire comprising the tread of claim 1.
